(19) United States
(12) Patent Application Publication
(10) Pub. No.: US 2026/0154856 A1
(43) Pub. Date: Jun. 4, 2026

(54) GENERALIZED ZERO-SHOT CONTENT-STYLE COMPOSITION

(71) Applicant: QUALCOMM Incorporated, San Diego, CA (US)

(72) Inventors: Mohammad Reza KARIMI DASTJERDI, San Diego, CA (US); Kartikeya BHARDWAJ, San Diego, CA (US); Shubhankar Mangesh BORSE, San Diego, CA (US); Ankita NAYAK, Milpitas, CA (US); Edward TEAGUE, San Diego, CA (US); Fatih Murat PORIKLI, San Diego, CA (US)

(21) Appl. No.: 19/215,080

(22) Filed: May 21, 2025

Related U.S. Application Data
(60) Provisional application No. 63/727,121, filed on Dec. 2, 2024.

(51) Int. Cl. G06T 11/00; G06V 10/74

(52) U.S. Cl. CPC G06T 11/00; G06V 10/761

(57) ABSTRACT

Systems and techniques are described herein for generating an image. For instance, a process can include generating, by a style adapter for a pretrained machine learning model, a style embedding based on an input style image; generating, by a content adapter for the pretrained machine learning model, a content embedding based on an input content image; combining the style embedding and the content embedding to generate a combined embedding; and generating, using the pretrained machine learning model, an output image based on the combined embedding.

### CROSS-REFERENCE TO RELATED APPLICATIONS

This application claims the benefit of U.S. Provisional Patent Application No. 63/727,121, filed Dec. 2, 2024, which is hereby incorporated by reference in its entirety and for all purposes.

### FIELD

The present disclosure generally relates to generating images. For example, aspects of the present disclosure are related to systems and techniques for performing generalized zero-shot content-style composition for generating images using pretrained generative machine learning (ML) models.

### BACKGROUND

Generative models are artificial intelligence/machine learning (AI/ML) models which may be trained to generate content, such as images, text, videos, etc. Generative models can generate image data based on a prompt, such as text or another image. For example, a text and/or image may be submitted as a prompt for a generative model, and the generative model may generate an image using a subject of the image, such as a dog, and place the dog in a novel situation, such as in a bucket. Image data generated by the generative machine-learning (ML) model may be new image data (e.g., based on the training of the generative ML model). The new image data may be conditioned on the provided image but may not be replicated from the provided image.

To enable a generative ML model to generate, for example, images in a certain style and/or content, the generative ML model, or an adapter for the generative ML model, may need to be trained on that style/content. Such a training technique can limit scalability as retraining can be difficult and/or expensive. Additionally, generative ML models prompted with an image can leak irrelevant content (e.g., elements from the background) into generated images. In some cases, techniques to generalize content/style composition for generative models may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for generating an image with generalized content/style composition using a pretrained generative machine-leaning model.

In various illustrative examples, an apparatus for generating an image is provided. The apparatus, includes: at least one memory; and at least one processor coupled to the at least one memory and configured to: generate, using a style adapter for a pretrained machine learning model, a style embedding based on an input style image; generate, using a content adapter for the pretrained machine learning model, a content embedding based on an input content image; combine the style embedding and the content embedding to generate a combined embedding; and generate, using the pretrained machine learning model, an output image based on the combined embedding. A pretrained ML model may be a ML model which was previously trained and is being run (unless otherwise noted) without having to update the weights or other parameters of the pretrained ML model as a part of additional training.

In various illustrative aspects, a method for generating an image is provided. The method includes: generating, by a style adapter for a pretrained machine learning model, a style embedding based on an input style image; generating, by a content adapter for the pretrained machine learning model, a content embedding based on an input content image; combining the style embedding and the content embedding to generate a combined embedding; and generating, using the pretrained machine learning model, an output image based on the combined embedding.

In various illustrative aspects, a non-transitory computer-readable medium having stored thereon instructions that, when executed by at least one processor, cause the at least one processor to: generate, using a style adapter for a pretrained machine learning model, a style embedding based on an input style image; generate, using a content adapter for the pretrained machine learning model, a content embedding based on an input content image; combine the style embedding and the content embedding to generate a combined embedding; and generate, using the pretrained machine learning model, an output image based on the combined embedding.

In various illustrative aspects, an apparatus for generating an image is provided. The apparatus includes: means for generating, by a style adapter for a pretrained machine learning model, a style embedding based on an input style image; means for generating, by a content adapter for the pretrained machine learning model, a content embedding based on an input content image; means for combining the style embedding and the content embedding to generate a combined embedding; and means for generating, using the pretrained machine learning model, an output image based on the combined embedding.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) include at least one camera for capturing one or more images or video frames. For example, the apparatus(es) can include a camera (e.g., an RGB camera) or multiple cameras for capturing one or more images and/or one or more videos including video frames. In some aspects, the apparatus(es) can include a display for displaying one or more images, videos, notifications, or other displayable data. In some aspects, the apparatus(es) can include a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with some examples;

FIG. 2 is a block diagram illustrating an example of a deep learning neural network, according to some aspects;

FIG. 3 is a block diagram illustrating an example of a convolutional neural network (CNN), according to various aspects of the present disclosure;

FIG. 4 provides two sets of images that show the forward diffusion process (which is fixed) and the reverse diffusion process (which is learned) of a diffusion model, in accordance with some aspects;

FIG. 5 is a diagram illustrating how diffusion data is distributed from initial data to noise using a diffusion model in the forward diffusion direction, in accordance with some aspects;

FIG. 6 is a diagram illustrating a U-Net architecture for a diffusion model, in accordance with some aspects;

FIG. 7 illustrates an architecture for training a ML model for generalized zero-shot content-style composition for generating images, in accordance with aspects of the present disclosure;

FIG. 8 illustrates an application of Lang-segment anything model (Lang-SAM) for determining a content loss, in accordance with aspects of the present disclosure;

FIG. 9 illustrates an architecture for a ML model for generalized zero-shot content-style composition for generating images, in accordance with aspects of the present disclosure;

FIG. 10 is a flow diagram illustrating a process for generating an image, in accordance with aspects of the present disclosure; and

FIG. 11 illustrates an example computing device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Generative models may be used in various ways to generate content, such as images. One such way is a content-style composition. In content-style compositions, a particular type of content, such as specific person, pet, toy, etc. may be provided along with an image of a particular type of style, and a prompt and the generative model may generate an image, in the style of the input image, including the content based on the prompt, such as by placing the content in a novel situation.

Generative models for generating images may be implemented as a latent diffusion model trained on a general dataset of images. In some cases, a generative model may support low rank adaptation (LoRA), which may allow a pretrained, frozen, ML model (e.g., ML model with frozen weights) to be adapted to different tasks using trainable matrices (e.g., for cross-attention) in layers of the pretrained ML model. In some cases, to allow a generative ML model to perform content-style composition, content- or style-specific LoRAs (i.e., LoRAs trained on specific content or specific styles) may be used to train the generative model to generate images with the specific content or specific style. However, such techniques are difficult to scale as training a ML model or LoRA can be expensive and may use many different images (e.g., training images) of the specific content or style, which may, or may not, be available. Other techniques for content-style composition may utilize heavy and/or expensive ML model architectures that may not be suitable for mobile devices or other devices with constrained computing and/or battery power or may have relatively low quality and leak irrelevant content from a reference image into the generated images.

In some cases, a trained style adapter and a trained content adapter (e.g., LoRA adapters) may be used to perform generalized content-style composition with a pretrained generative model, such as a diffusion model. In some cases, generalized content-style composition may refer to being able to generate images for any content and/or style without having to train individual adapters for different contents and/or styles. Allowing a trained adapter to perform generalized content-style composition with a pretrained generative model may be useful to expand the use of such generative models for lower-powered and/or memory-constrained devices by reducing a number of adapters used to perform different tasks. Similarly, an adapter to perform generalized content-style composition may be leveraged to reduce computational power, memory usage, and/or power usage for datacenters by reducing the use of adapters trained to perform specific tasks. Additionally, as an adapter to perform generalized content-style composition can be trained once, as compared to training multiple adapters, the amount of time and cost used for adapting a frozen ML model to perform new tasks may be reduced, potentially allowing for smaller and/or less-resourced competitors access to market.

Systems, apparatuses, electronic devices, methods (also referred to as processes), and computer-readable media (collectively referred to herein as “systems and techniques”) are described for generalized zero-shot content-style composition for generating images. In some cases, pretrained generative models may be leveraged to perform generalized zero-shot composition using adapters. For example, a style adapter may be used to generate a style embedding based on an input style image. In some cases, the style adapter includes at least one of an object detector ML model (e.g., DINO, DINOv2, etc.; DINO is described for example in “Emerging Properties in Self-Supervised Vision Transformers” arXiv:2104.14294v2, section 3 of which is incorporated herein by reference) or style recognition model (e.g., contrastive style descriptor (CSD) model, which is described for example in “Measuring Style Similarity in Diffusion Models” arXiv:2404.01292v1, section 5 of which is incorporated herein by reference; or the like) for encoding the style of the input style image.

A content adapter may also be used to generate a content embedding based on an input content image. In some cases, the content adapter includes the object detector ML model for encoding content of the input content image. The style embedding and content embedding may be combined to generate a combined embedding. The style embedding and content embedding may be combined using a weighted summation, attention feature aggregation, and/or an adaptive instance normalization. The combined embedding can be input to the pretrained generative model for processing along with noise (e.g., noise image).

The pretrained generative model may then generate an output image from a noise image (e.g., noise seed) based on the combined embedding. The output image may be in the same style as the style image with the content of the content image.

In some cases, to train the content adapter and the style adapter, the pretrained generative model may generate a first intermediate image (e.g., new image) based on the noise image using the combined embedding. An intermediate image may be a partially denoised image generated as a part of a reverse diffusion process between the noise image and a final, denoised, image. An estimated generated image (e.g., final, denoised image) may be predicted from the first intermediate image. A style recognition model may be used to generate first style information (e.g., features describing the style) for the input style image. The style recognition model may also be used to generate second style information for the estimated generated image. A style loss may be determined between the first style information and the second style information. The style loss may be used to train (e.g., update weights of) the style adapter. In some cases, the style loss may be determined based on a cosine similarity between the first style information and the second style information.

Similarly, the content adapter may be trained by using an object detector model to generate first content information (e.g., features describing the content) for the input content image. The content detector model may generate second content information for the estimated generated image. A content loss may be determined based on the first content information and the second content information. The content loss may be used to train the content adapter.

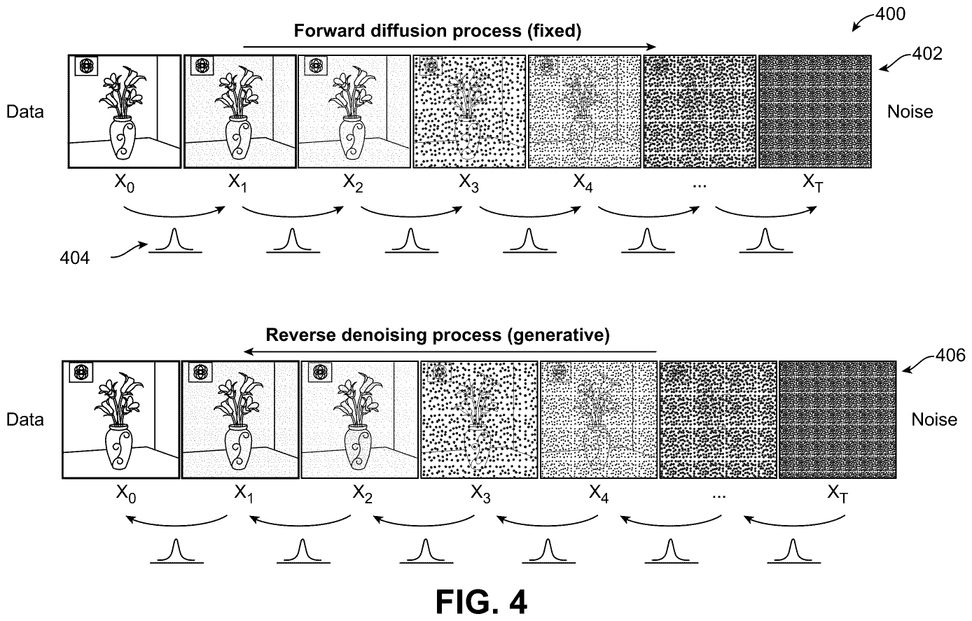

In some cases, the content loss may be determined using a cosine similarity operation between the first intermediate image and a second intermediate image to preserve content from the input content image. The second intermediate image may be generated for a different time step (e.g., a different image of a second set of images 406 of FIG. 4) as compared to the first intermediate image. In some cases, a language segment anything model (Lang-SAM) may also be used to determine the content loss. For example, the Lang-SAM may identify specific content in the input content image and content in the first intermediate image. The content loss may be determined based on a similarity between the identified content in the input content image and the identified content in the first intermediate image.

In some cases, a pretrained vision-language model (VLM) with frozen weights (e.g., weights that are not trained during subsequent training processes) may be adapted to perform tasks that the original VLM may not have been capable of. In some cases, general VLMs may be relatively large and substantial computing resources may be used to train the general VLMs. As training a general VLM from scratch can be expensive with respect to computing resources and time, it may be useful to leverage existing pretrained general VLM models with frozen weights to perform generalized content-style compositions to generate images for any content and/or style.

Various aspects of the present disclosure will be described with respect to the figures.

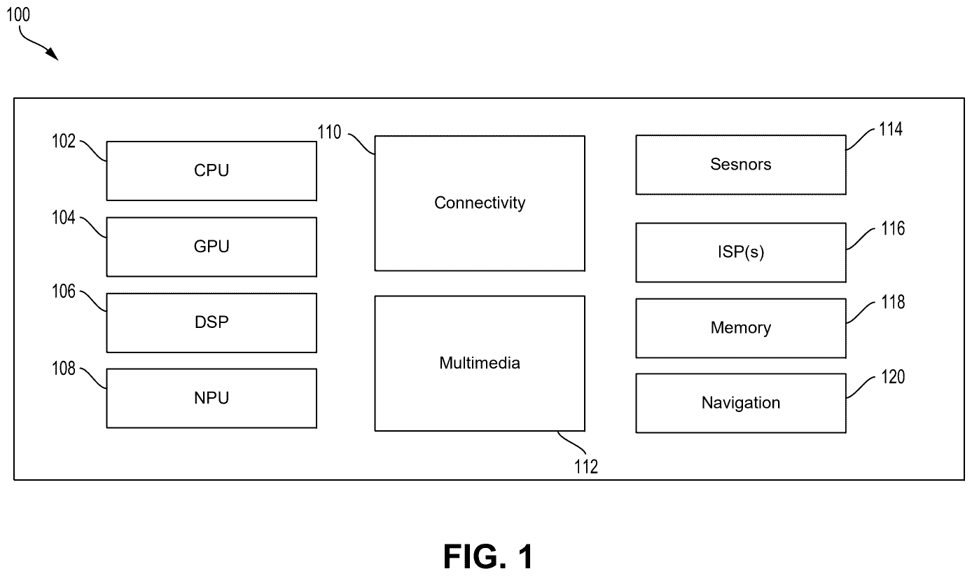

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

Machine learning (ML) can be considered a subset of artificial intelligence (AI). ML systems can include algorithms and statistical models that computer systems can use to perform various tasks by relying on patterns and inference, without the use of explicit instructions. One example of an ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, diffusion-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

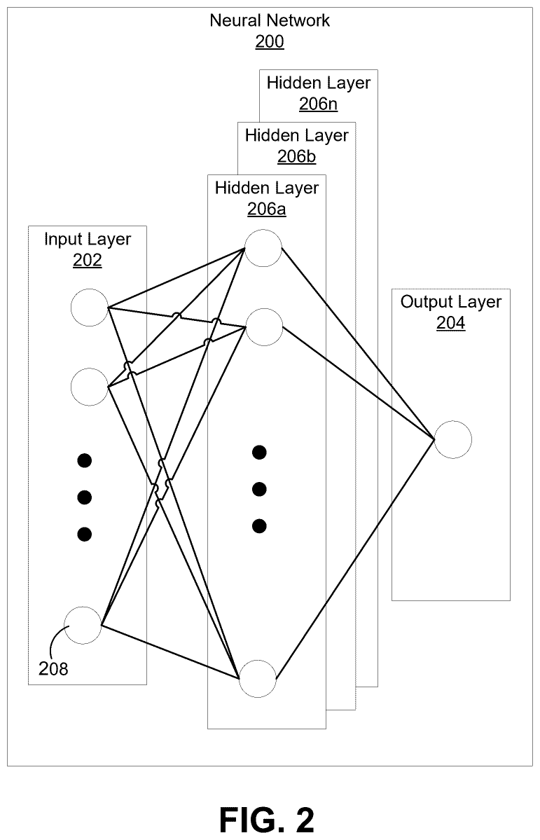

FIG. 2 is an illustrative example of a neural network 200 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation.

An input layer 202 includes input data. Neural network 200 includes multiple hidden layers hidden layers 206a, 206b, through 206n. The hidden layers 206a, 206b, through hidden layer 206n include “n” number of hidden layers, where “n” is an integer greater than or equal to one. The number of hidden layers can be made to include as many layers as needed for the given application. Neural network 200 further includes an output layer 204 that provides an output resulting from the processing performed by the hidden layers 206a, 206b, through 206n.

Neural network 200 may be, or may include, a multi-layer neural network of interconnected nodes. Each node can represent a piece of information. Information associated with the nodes is shared among the different layers and each layer retains information as information is processed. In some cases, neural network 200 can include a feed-forward network, in which case there are no feedback connections where outputs of the network are fed back into itself. In some cases, neural network 200 can include a recurrent neural network, which can have loops that allow information to be carried across nodes while reading in input.

Information can be exchanged between nodes through node-to-node interconnections between the various layers. Nodes of input layer 202 can activate a set of nodes in the first hidden layer 206a. For example, as shown, each of the input nodes of input layer 202 is connected to each of the nodes of the first hidden layer 206a. The nodes of first hidden layer 206a can transform the information of each input node by applying activation functions to the input node information. The information derived from the transformation can then be passed to and can activate the nodes of the next hidden layer 206b, which can perform their own designated functions. Example functions include convolutional, up-sampling, data transformation, and/or any other suitable functions. The output of the hidden layer 206b can then activate nodes of the next hidden layer, and so on. The output of the last hidden layer 206n can activate one or more nodes of the output layer 204, at which an output is provided. In some cases, while nodes (e.g., node 208) in neural network 200 are shown as having multiple output lines, a node has a single output and all lines shown as being output from a node represent the same output value.

In some cases, each node or interconnection between nodes can have a weight that is a set of parameters derived from the training of neural network 200. Once neural network 200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 200 to be adaptive to inputs and able to learn as more and more data is processed.

Neural network 200 may be pretrained to process the features from the data in the input layer 202 using the different hidden layers 206a, 206b, through 206n in order to provide the output through the output layer 204. In an example in which neural network 200 is used to identify features in images, neural network 200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 200 is trained well enough so that the weights of the layers are accurately tuned.

For the example of identifying objects in images, the forward pass can include passing a training image through neural network 200. The weights are initially randomized before neural network 200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

Neural network 200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 200 can include any other deep network other than a CNN, such as an autoencoder, a deep belief nets (DBNs), a Recurrent Neural Networks (RNNs), among others.

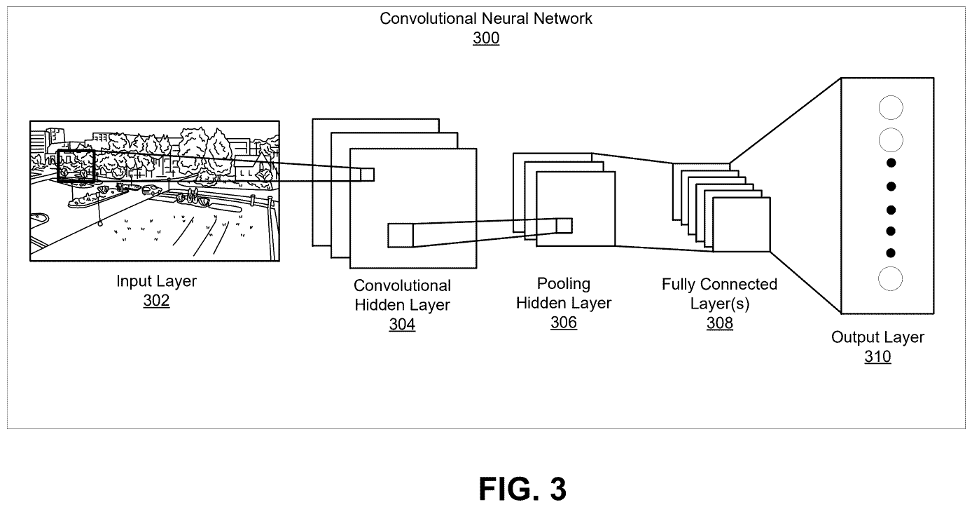

FIG. 3 is an illustrative example of a convolutional neural network (CNN) 300. The input layer 302 of the CNN 300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 304, an optional non-linear activation layer, a pooling hidden layer 306, and fully connected layer 308 (which fully connected layer 308 can be hidden) to get an output at the output layer 310. While only one of each hidden layer is shown in FIG. 3, one of ordinary skill will appreciate that multiple convolutional hidden layers, non-linear layers, pooling hidden layers, and/or fully connected layers can be included in the CNN 300. As previously described, the output can indicate a single class of an object or can include a probability of classes that best describe the object in the image.

The first layer of the CNN 300 can be the convolutional hidden layer 304. The convolutional hidden layer 304 can analyze image data of the input layer 302. Each node of the convolutional hidden layer 304 is connected to a region of nodes (pixels) of the input image called a receptive field. The convolutional hidden layer 304 can be considered as one or more filters (each filter corresponding to a different activation or feature map), with each convolutional iteration of a filter being a node or neuron of the convolutional hidden layer 304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 304. Each connection between a node and a receptive field for that node learns a weight and, in some cases, an overall bias such that each node learns to analyze its particular local receptive field in the input image. Each node of the convolutional hidden layer 304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 304 is due to each node of the convolutional layer being applied to its corresponding receptive field. For example, a filter of the convolutional hidden layer 304 can begin in the top-left corner of the input image array and can convolve around the input image. As noted above, each convolutional iteration of the filter can be considered a node or neuron of the convolutional hidden layer 304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 304.

The mapping from the input layer to the convolutional hidden layer 304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 304 can include several activation maps in order to identify multiple features in an image. The example shown in FIG. 3 includes three activation maps. Using three activation maps, the convolutional hidden layer 304 can detect three different kinds of features, with each feature being detectable across the entire image.

In some examples, a non-linear hidden layer can be applied after the convolutional hidden layer 304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 300 without affecting the receptive fields of the convolutional hidden layer 304.

The pooling hidden layer 306 can be applied after the convolutional hidden layer 304 (and after the non-linear hidden layer when used). The pooling hidden layer 306 is used to simplify the information in the output from the convolutional hidden layer 304. For example, the pooling hidden layer 306 can take each activation map output from the convolutional hidden layer 304 and generates a condensed activation map (or feature map) using a pooling function. Max-pooling is one example of a function performed by a pooling hidden layer. Other forms of pooling functions be used by the pooling hidden layer 306, such as average pooling, L2-norm pooling, or other suitable pooling functions. A pooling function (e.g., a max-pooling filter, an L2-norm filter, or other suitable pooling filter) is applied to each activation map included in the convolutional hidden layer 304. In the example shown in FIG. 3, three pooling filters are used for the three activation maps in the convolutional hidden layer 304.

In some examples, max-pooling can be used by applying a max-pooling filter (e.g., having a size of 2×2) with a stride (e.g., equal to a dimension of the filter, such as a stride of 2) to an activation map output from the convolutional hidden layer 304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 304 having a dimension of 24×24 nodes, the output from the pooling hidden layer 306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. The positional information can be discarded without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 300.

The final layer of connections in the network is a fully connected layer that connects every node from the pooling hidden layer 306 to every one of the output nodes in the output layer 310. Using the example above, the input layer includes 28×28 nodes encoding the pixel intensities of the input image, the convolutional hidden layer 304 includes 3×24×24 hidden feature nodes based on application of a 5×5 local receptive field (for the filters) to three activation maps, and the pooling hidden layer 306 includes a layer of 3×12×12 hidden feature nodes based on application of max-pooling filter to 2×2 regions across each of the three feature maps. Extending such an example, the output layer 310 can include ten output nodes. In such an example, every node of the 3×12×12 pooling hidden layer 306 is connected to every node of the output layer 310.

The fully connected layer 308 can obtain the output of the previous pooling hidden layer 306 (which should represent the activation maps of high-level features) and determines the features that most correlate to a particular class. For example, the fully connected layer 308 can determine the high-level features that most strongly correlate to a particular class and can include weights (nodes) for the high-level features. A product can be computed between the weights of the fully connected layer 308 and the pooling hidden layer 306 to obtain probabilities for the different classes. For example, if the CNN 300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 310 can include an M-dimensional vector (in the prior example, M=10). M indicates the number of classes that the CNN 300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 4 provides two sets of images 400 that show a forward diffusion process (which is fixed) and a reverse diffusion process (which is learned) of a diffusion model. As shown in the forward diffusion process of FIG. 4, noise 404 is gradually added to a first set of images 402 at different time steps for a total of T time steps (e.g., making up a Markov chain), producing a sequence of noisy samples X₁ through X_{T}.

Diffusion models from a training perspective will take an image and will slowly add noise to the image to destroy the information in the image. In some aspects, the noise 404 is Gaussian noise. Each time step can correspond to each consecutive image of the first set of images 402 shown in FIG. 4. The initial image X₀ of FIG. 4 is of a vase. Addition of the noise 404 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-mean Gaussian [symbol] (0, 1).

The second set of images 406 shows the reverse diffusion process in which X_{T} is the starting point with a noise image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 4, the reverse diffusion process proceeds to generate X_{θ} as the image of a vase. In other cases, the input data and output data can vary based on the task for which the diffusion model is trained.

As noted above, the diffusion model is trained to be able to denoise or recover the original image X₀ in an incremental process as shown in the second set of images 406. In some aspects, the neural network of the diffusion model can be trained to recover Xₜ₋₁ given Xₜ, such as provided in the below example equation:

$$q ( {x}_{t} \vert {x}_{t - 1} ) = 𝒩 ( {x}_{t} ; \sqrt{1 - {β}_{t}} {x}_{t - 1} , {β}_{t} I ) .$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = 𝒩 ( {x}_{t} ; \sqrt{{\hat{∝}}_{t}} {x}_{0} , ( 1 - {\hat{∝}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε ∼ 𝒩 ( 0 , I ) .$$

In some cases, the βₜ values schedule (also referred to as a noise schedule) is designed such that \hat{∝}_{T}→0 and q(x_{T}|x₀)≈ [symbol] (x_{T}; 0, 1).

The diffusion model runs in an iterative manner to incrementally generate the input image X₀. In one example, the model may have twenty steps. However, in other examples, the number of steps can vary.

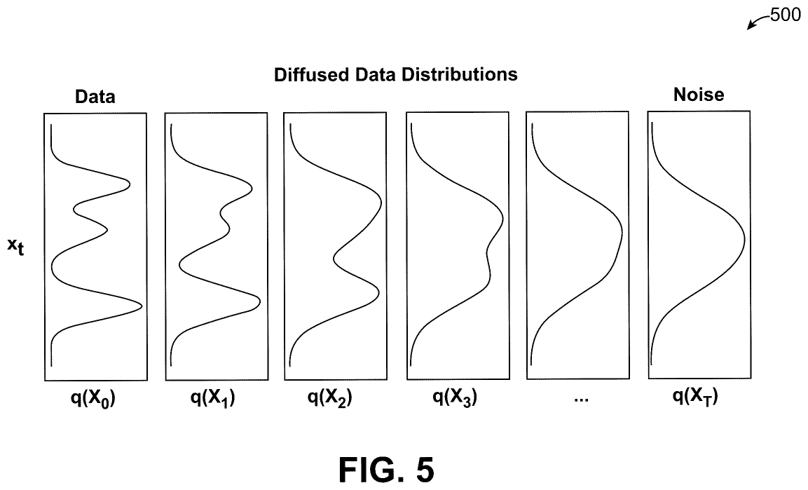

FIG. 5 is a diagram 500 illustrating how diffusion data is distributed from initial data to noise using a diffusion model in the forward diffusion direction, in accordance with some aspects. Note that the initial data q(X₀) is detailed in the initial stage of the diffusion process. An illustrative example of the data q(X₀) is the initial image of the vase shown in FIG. 4. As the diffusion model iterates and iteratively adds sampled noise to the data from t=0 to t=T, as shown in FIG. 5, the data becomes noisier and may ultimately result in pure noise (e.g., at q(X_{T})). The example of FIG. 5 illustrates the progression of the data and how it becomes diffused with noise in the forward diffusion process.

In some aspects, the diffused data distribution (e.g., as shown in FIG. 5) can be as follows:

$$q ( {x}_{t} ) = \int q ( {x}_{0} , {x}_{t} ) {dx}_{0} = \int q ( {x}_{0} ) q ( {x}_{t} \vert {x}_{0} ) d {x}_{0} .$$

In the above equation, q(xₜ) represents the diffused data distribution, q(x₀, xₜ) represents the joint distribution, q(x₀) represents the input data distribution, and q(xₜ|x₀) is the diffusion kernel. In this regard, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

| 1: | repeat |
|---|---|
| 2: | x₀ ~ q(x₀) |
| 3: | t ~ Uniform ({1,...,T }) |
| 4: | ∈ ~ [symbol] (0, I) |
| 5: | Take gradient descent step on |
| ∇_{Ø} \|\| ∈ − ∈_{Ø} (\sqrt{\hat{∝}ₜ x₀}+ \sqrt{1 − \hat{∝}ₜ}∈, t) \|\|² | |
| 6: | until converged |

A sampling algorithm can include the following steps:

1: x_{T} ~ [symbol] (0, I)
2: for t = T, . . . , 1 do
3: z ~ [symbol] (0, I)
$4. {x}_{t - 1} = \frac{1}{\sqrt{{\hat{∝}}_{t}}} ( {x}_{t} - \frac{1 - {\hat{∝}}_{t}}{\sqrt{1 - {\hat{∝}}_{t}}} {ϵ}_{∅} ( {x}_{t} , t ) ) + {σ}_{t} z$
5: end for
6: return x₀

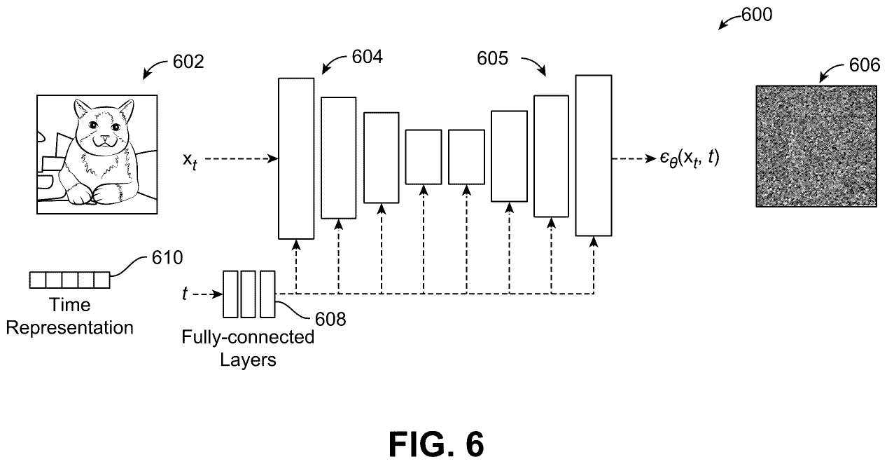

FIG. 6 is a diagram illustrating a U-Net architecture 600 for a diffusion model, in accordance with some aspects. The initial image 602 (e.g., of a cat) is provided to the U-Net architecture 600 which includes a series of residual networks (ResNet) blocks and self-attention layers to represent the network ∈_{ø}(xₜ, t). The U-Net architecture 600 also includes fully connected layers 608. In some cases, time representation 610 can be one or more sinusoidal positional embeddings or random Fourier features. Noisy output 606 from the forward diffusion process is also shown.

The U-Net architecture 600 includes a contracting path 604 and an expansive path 605 as shown in FIG. 6, which gives it the U-shaped architecture. The contracting path 604 can be a convolutional network that includes repeated convolutional layers (that apply convolutional operations), each followed by a rectified linear unit (ReLU) and a max pooling operation. When images (e.g., the image 602) are being processed during the contracting path 604, the spatial information of the image 602 is reduced as features are generated. The expansive path 605 combines the features and spatial information through a sequence of up-convolutions and concatenations with high-resolution features from the contracting path 604. Some of the layers can be self-attention layers, which leverage global interactions between semantic features at the end of the encoder to explicitly model full contextual information.

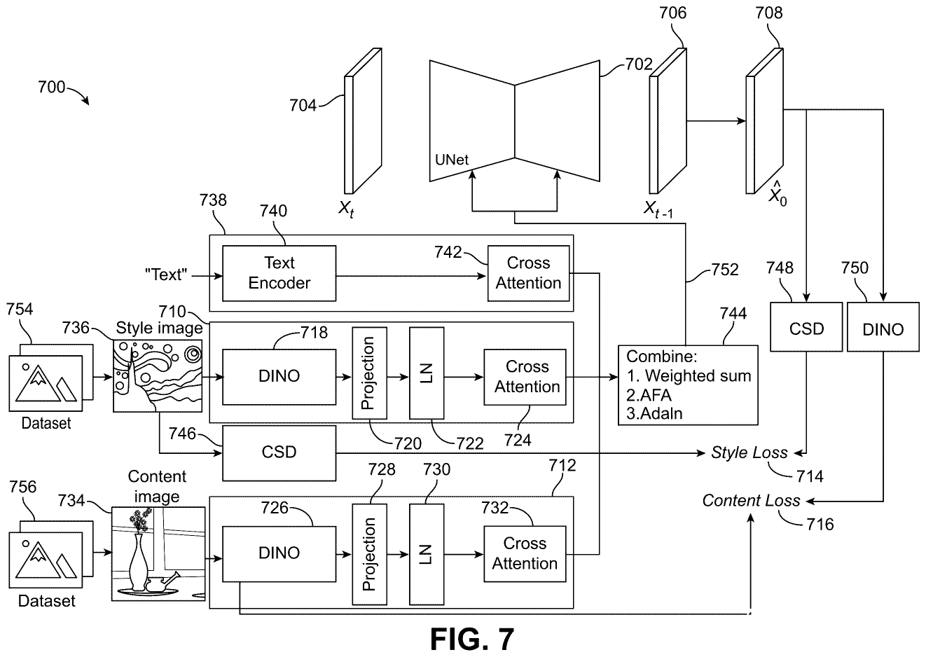

FIG. 7 illustrates an architecture for adapting a ML model for generalized zero-shot content-style composition 700 for generating images, in accordance with aspects of the present disclosure. In some cases, a pretrained generative machine learning (ML) model 702 may be an ML model trained to process visual content such as images, video, etc., to recognize and/or generate visual elements, such as objects, scenes, styles and so forth, generate text based on the visual content, and/or generate visual content based on text. In some cases, the pretrained generative ML model 702 may be a diffusion-based model, as described with respect to FIGS. 4-6. Examples of a pretrained generative ML model 702 may include Stable Diffusion, DALL-E, Midjourney, other U-Net based diffusion models, etc. As shown, the pretrained generative ML model 702 may reverse a diffusion process, and a noise image 704, at time step xₜ, may be passed into the pretrained generative ML model 702 to generate a new image 706 (e.g., intermediate image) that may be less noisy at time step xₜ₋₁.

Additionally, the pretrained generative ML model 702 may be configured to predict an estimated generated image 708 x₀ from a particular time step, such as the new image 706, using whatever information the pretrained generative ML model 702 has included in the new image 706. In some cases, the estimated generated image 708 may be estimated as \hat{x}₀=(xₜ−\sqrt{1−α̅ₜ}·∈_{θ}(xₜ))/\sqrt{α̅ₜ}, where āₜ is the product of individual αₜ values which are related to the variances (αₜ=1−varianceₜ) of noise added during the forward process, and ∈_{θ}(xₜ) represents the output of the pretrained generative ML model 702 that predicts the estimate of the noise added at the current time step t.

A generalist pretrained generative ML model, such as the pretrained generative model 702, may be relatively large and substantial computing resources may have been used to train the pretrained generative ML model 702. As training a pretrained generative ML model 702 from scratch can be expensive with respect to computing resources and time, it may be useful to leverage an existing pretrained generative ML model 702 with frozen weights. In some cases, a pretrained generative ML model 702 may be adapted to perform tasks that the original pretrained generative ML model 702 may not have been capable of using adapters. The pretrained generative ML model 702 may include support for one or more adapters.

In some cases, a style adapter 710 and a content adapter 712 may be trained to generate style information and content information, respectively. The training may be performed based in part on the estimated generated image 708 \hat{x}₀ using a style loss 714 and a content loss 716, respectively. The style information and content information may be combined in a way that is understandable to the pretrained generative ML model 702 to allow the pretrained generative ML model 702 to perform generalized zero-shot content-style composition.

In some cases, the style adapter 710 may be based on a pretrained encoder 718 coupled to one or more projection layers 720, linear layers 722, and cross-attention layers 724. For instance, the projection layers 720 and linear layers 722 can be used to make the dimensions of the pretrained encoder compatible with that of the pretrained generative ML model 702. The cross-attention layers 724 can be used to compute the attention between the image signals coming from the pretrained generative ML model 702 (e.g., the main part of image generation) with the style or content embedding signal coming from the reference style or content images. For instance, cross-attention is how the content or style is combined with the image generation process. In order for the cross-attention layers 724 to compute the cross-attentions, the style and content embeddings (e.g., tensors/vectors) can be modified by the projection layers 720 and linear layers 722 to make the dimension of the embeddings compatible with those of the pretrained generative ML model 702.

In some cases, the pretrained encoder 718 may be an object detector ML model, such as (but not limited to) DINO, DINOv2, a Contrastive Language-Image Pre-Training (CLIP) image encoder, a contrastive style descriptor (CSD), etc. That is, the object detector ML model may be an ML model trained to detect objects in an image, segment an image, draw a bounding box around an image, etc. The object detector ML model may be used as a style adapter to extract and/or characterize objects having style elements in a style image 736. In other cases, the pretrained encoder 718 of the style adapter 710 may be a style recognition ML model, such as CSD model or the like, which may be trained to detect and/or extract stylistic elements (e.g., features describing the style) of the style image 736, such as types of colors, textures, patterns, or shapes present in the style image 736. For example, an image may be input to the CSD model, which may output features describing the style of the image (e.g., style features, also referred to as a style embedding). In some cases, the pretrained encoder 718 may output the style embedding for input to one or more projection layers 720, linear layers 722, and/or cross-attention layers 724 that may be trained to project the style embedding output by the pretrained encoder 718 into an attention space for cross-attention by the pretrained generative ML model 702.

In some cases, as the style adapter 710 and content adapter 712 utilize pretrained encoders (e.g., pretrained encoder 718, pretrained encoder 726), training may be performed for specific layers (e.g., the projection layers, linear layers, and/or cross-attention layers) rather than for the entire adapter, thus simplifying and/or focusing training.

In some cases, the content adapter 712 may also be based on a pretrained encoder 726 coupled to one or more projection layers 728, linear layers 730, and/or cross-attention layers 732. In some cases, the pretrained encoder 726 may be an object detector ML model, such as (but not limited to) DINO, DINOv2, a CLIP image encoder etc., which may be ML models trained to detect objects in an image, segment an image, draw a bounding box around an image, etc. For example, an image, such as (but not limited to) content image 734, may be input to a DINO model, which may output features describing content from the image. The object detector ML model may be used in the content adapter 712 to identify and determine features of the content from an input content image 734. The pretrained encoder 726 may output a content embedding (e.g., content features) for the pretrained generative ML model 702 and the one or more projection layers 728, linear layers 730, and/or cross-attention layers 732 may be trained to project the content embedding output by the pretrained encoder 726 into an attention space for cross-attention by the pretrained generative ML model 702.

In some cases, a text adapter 738 including a text encoder 740 (e.g., a CLIP-Text encoder model or other type of model) may generate a text embedding, for example, input prompt text. The input prompt text may indicate, for example, instructions for the image to be generated, such as “vase in the style of Van Gogh.” In some cases, the text adapter 738 may include one or more cross-attention layers 742.

In some cases, the text embedding, style embedding, and content embedding may be combined by a combiner 744 for integration into the pretrained generative ML model 702. For example, the pretrained generative ML model 702 may expect a certain type of information that may be input, and the combiner 744 may combine the text embedding, style embedding, and content embedding into a combined embedding 752 that is compatible with the pretrained generative ML model 702. The combined embedding 752 may be input to the pretrained generative ML model 702.

As indicated above, the pretrained generative ML model 702 may receive the noise image 704 and generate the new image 706 based on the input combined embedding 752 that was generated based on (at least) the input content image 734 and style image 736. In some cases, the new image 706 may be used to predict the estimated generated image 708 \hat{x}₀, and the estimated generated image 708 \hat{x}₀ may be used to determine the style loss 714 and content loss 716 for training the style adapter 710 (e.g., the one or more projection layers 720, linear layers 722, and/or cross-attention layers 724) and content adapter 712 (e.g., the one or more projection layers 728, linear layers 730, and/or cross-attention layers 732), respectively.

For example, for an input style image 736, the estimated generated image 708 \hat{x}₀ should be in a style of the style image 736. Thus, style information (e.g., image features describing the style) extracted from the estimated generated image 708 \hat{x}₀ should match style information extracted from the input style image 736. Therefore, the input style image 736 may be input to a pretrained style recognition ML model, such as CSD 746, to obtain style information that may be used to determine the style loss 714. In cases where a style recognition ML model is used as the pretrained encoder 718, style embedding output by the pretrained encoder 718 may be used to determine the style loss 714 such that CSD 746 is not required. As indicated above, an object detector ML model may be used advantageously as the pretrained encoder 718 to extract and/or characterize objects having style elements to allow the style from the object(s) in the style image 736 to be extracted. Using a style recognition ML model may be used to extract and/or characterize an overall style of the style image 736.

The estimated generated image 708 \hat{x}₀ may also be passed into the same pretrained style recognition ML model, such as CSD 748 or the like, to obtain style information. The style loss 714 may be determined based on a comparison between the style information output from CSD 746 (or the like) and the style information output from CSD 748. In some aspects, rather than being separate models, CSD 746 (or 718) and CSD 748 may be implemented by accessing the same model stored in memory using style image 736 and estimated generated image 708 \hat{x}₀ as inputs, respectively. The determined style loss 714 may be used to adjust the weights of (e.g., train) the one or more projection layers 720, linear layers 722, and/or cross-attention layers 724 of the style adapter 710. In some cases, the style adapter 710 may be trained separately from the content adapter 712 based on a dataset 754, such as the ContraStyles dataset or the like.

Similarly, for an input content image 734, the estimated generated image 708 x₀ should include the content from the input content image 734. Thus, content information (e.g., image features describing the content) extracted from the estimated generated image 708 \hat{x}₀ should match the content information extracted from the input content image 734. Therefore, the input content image 734 may be input to the pretrained encoder 726 (e.g., object detector ML model) to obtain content information that may be used to determine the content loss 716. The estimated generated image 708 x₀ may also be passed into the same object detector ML model (e.g., DINO 750 or the like). The content loss 716 may then be determined based on a comparison between the content information output from the pretrained encoder 726 and the object detector ML model (e.g., DINO 750). Similarly, as for style loss, rather than being separate models, pretrained encoder 726 and DINO 750 may be implemented by accessing the same model stored in memory using content image 734 and estimated generated image 708 \hat{x}₀ as inputs, respectively. The determined content loss 716 may be used to train (e.g., to adjust the weights of) the one or more projection layers 728, linear layers 730, and/or cross-attention layers 732 of the content adapter 712. In some cases, the content adapter 712 may be trained separately from the style adapter 710 based on a dataset 756, such as the MS COCO dataset or the like.

As indicated above, the style loss 714 may be determined based on a comparison between the style information output from CSD 746 and the style information output from CSD 748. In some cases, the style loss 714 may be expressed as Stylel [symbol] oss= [symbol] _{denoising}+γ·D_{cosine}(CSD(X₀), CSD(\hat{x}₀|xₜ)), where [symbol] _{denoising} may be a standard diffusion denoising loss (included to allow the diffusion to continue to operate), where CSD(X₀) represents features output by CSD 746 determined based on the style image 736, where CSD(\hat{x}₀|xₜ) represents the features output by CSD 748 determined based on the estimated generated image 708 \hat{x}₀ from the noise image 704, and where γ·D_{cosine} determines how similar (e.g., cosine similarity) the features output by CSD 746 and the features output by CSD 748 are. Ideally, the features should be the same.

As indicated above, the content loss 716 may be determined based on a comparison between the content information output from the pretrained encoder 726 and the object detector ML model (e.g., DINO 750). In some cases, diffusion models may generate different images given a different input noise image 704. However, for a content-style composition, the content from the input content image 734 should be preserved (e.g., a specific dog in the content image 734 should appear in an output image, despite different noise seeds). The content loss 716 may help enforce preserving the content from the content image 734.

In some cases, the content loss 716 may be expressed as

$$Content Loss = {ℒ}_{denoising} + ( {γ}_{1} \cdot ( {D}_{cosine} ( DINO ( {X}_{0} ) , DINO ( {\hat{x}}_{0}^{1} \vert {x}_{t} ) ) + {D}_{cosine} ( DINO ( {X}_{0} ) , DINO ( {\hat{x}}_{0}^{2} \vert {x}_{t}^{2} ) ) ) + {γ}_{2} \cdot {D}_{cosine} ( DINO ( {\hat{x}}_{0}^{1} \vert {x}_{t} ) , DINO ( {\hat{x}}_{0}^{2} \vert {x}_{t}^{2} ) ) ) + ( {γ}_{3} \cdot ( {D}_{cosine} ( DINO ( SAM ( {X}_{0} ) ) , DINO ( SAM ( {\hat{x}}_{0}^{1} \vert {x}_{t} ) ) ) + {D}_{cosine} ( DINO ( SAM ( {X}_{0} ) ) , DINO ( SAM ( {\hat{x}}_{0}^{2} \vert {x}_{t}^{2} ) ) ) ) ) .$$

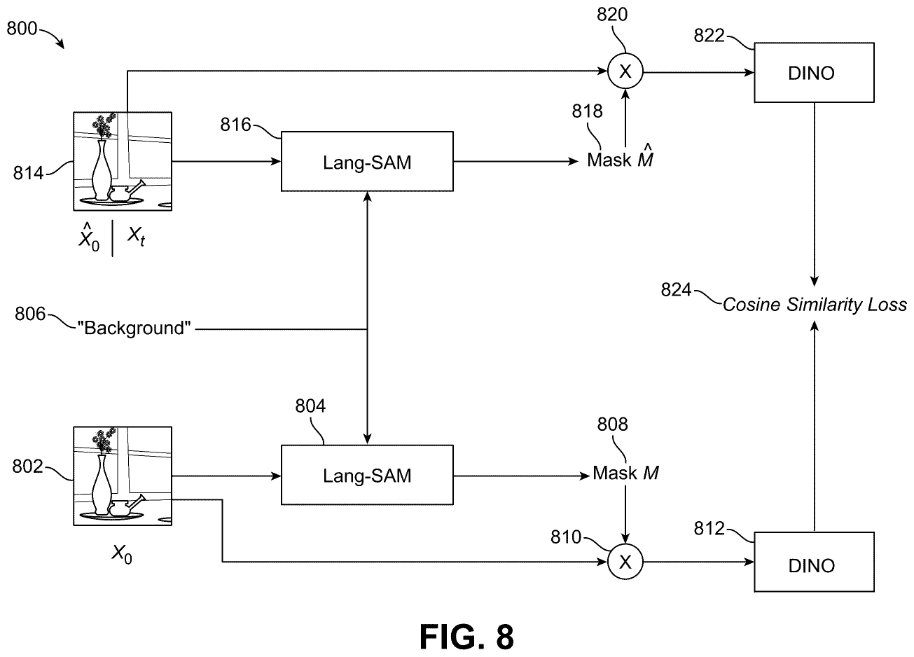

SAM( ) indicates that language segment anything (Lang-SAM) processing is applied, as explained in greater detail with regard to FIG. 8. In some cases, the portion of the content loss 716 that may enforce preserving the content from the content image 734 may be.

$${γ}_{1} \cdot ( {D}_{cosine} ( DINO ( {X}_{0} ) , DINO ( {\hat{x}}_{0}^{1} \vert {x}_{t} ) ) + {D}_{cosine} ( DINO ( {X}_{0} ) , DINO ( {\hat{x}}_{0}^{2} \vert {x}_{t}^{2} ) ) ) + {γ}_{2} \cdot {D}_{cosine} ( DINO ( {\hat{x}}_{0}^{1} \vert {x}_{t} ) , DINO ( {\hat{x}}_{0}^{2} \vert {x}_{t}^{2} ) ) ,$$

which may be a contrastive loss for two different noise samples of the diffusion model that makes the diffusion model more consistent across noise seeds. Here, X₀ represents the content image 734,

$${\hat{x}}_{0}^{1} \vert {x}_{t}$$

may represent an output of a first noise sample from the diffusion model, and

$${\hat{x}}_{0}^{2} \vert {x}_{t}^{2}$$

may represent an output of a second noise sample from the diffusion model (e.g., where two noise samples (e.g., noise image 704) are used for the diffusion model), DINO(X₀) may represent features of the pretrained encoder 726 based on the content image 734,

$$D I N O ( {\hat{x}}_{0}^{1} \vert {x}_{t} )$$

may represent features from an estimated generated image 708 \hat{x}₀ at a first time step using a first noise sample, and

$$D I N O ( {\hat{x}}_{0}^{2} \vert {x}_{t}^{2} ) )$$

may represent features from an estimated generated image 708 \hat{x}₀ at a second time step using a second noise sample. In some cases, the cosine similarity operation may make the content features (e.g., DINO( )) consistent across different noise samples with the content image 734, thus making the content adapter 712 robust to random noise after training.

In some cases, an additional portion may be included in the content loss 716 to help reduce irrelevant content leakage. Irrelevant content leakage may occur when background objects in the content image 734 become included (leak) into an output image of the content-style composition. For example, a content image may include a dog and some flowers in the background and an output image that is supposed to include (e.g., based on a prompt) just the dog may also include the flowers in the background. In some cases, the additional portion may be based on a language segment anything (Lang-SAM) model or the like. The Lang-SAM model may segment an image based on an input prompt to generate a segmentation mask for an object identified in the prompt.

FIG. 8 illustrates an application of Lang-SAM 800 (or other similar model) for determining a content loss, in accordance with aspects of the present disclosure. In FIG. 8, a content image 802 (e.g., content image 734 of FIG. 7, may be input to Lang-Sam 804 along with a prompt 806 of “background.” In some cases, the prompt 806 may be provided programmatically. In some examples, the prompt 806 may indicate to the Lang-SAM 804 what element (e.g., background or the like) to segment in an input image (e.g., content image 802 or the like). As indicated above, Lang-Sam 804 may segment content image 802 based on the prompt 806 to generate a segmentation mask 808 of the background in the content image 802. The segmentation mask 808 may then be applied 810 to the content image 802 to remove the background pixels of the content image 802, leaving just the content. The content may then be passed into an object detector ML model 812 (e.g., pretrained encoder 726 of FIG. 7) to generate features of the content for the content image 802.

Similarly, an estimated generated image 814 (e.g., estimated generated image 708 \hat{x}₀ of FIG. 7) may be input to Lang-Sam 816 along with the prompt 806 of “background.” In some cases, Lang-Sam 816 may be the same model as Lang-Sam 804. In other cases, Lang-Sam 816 may be different from Lang-Sam 804. In some cases, the background may be segmented because the specific object corresponding with the content identified by a prompt at runtime may not be known in advance. The Lang-Sam 816 may segment the estimated generated image 814 based on the prompt 806 to generate a segmentation mask 818 of the background in the estimated generated image 814. The segmentation mask 818 may then be applied 820 to the estimated generated image 814 to remove the background pixels of the estimated generated image 814, leaving just the content. The content may then be passed into an object detector ML model 822 (e.g., DINO 750 of FIG. 7) to generate features of the content for the estimated generated image 814. In some cases, object detector ML model 822 may be the same model as object detector ML model 812. In other cases, object detected ML model 822 may be different from object detector ML model 812. In some cases, a cosine similarity loss 824 (e.g., D_{cosine}) or the like may be determined for features of the content for the content image 802 and features of the content for the estimated generated image 814 for the content loss (e.g., content loss 716 of FIG. 7).

Returning to FIG. 7, the portion of the content loss 716 that is based on Lang-SAM may be:

$${γ}_{3} \cdot ( {D}_{cosine} ( D I N O ( S A M ( {X}_{0} ) ) , D I N O ( S A M ( {\hat{x}}_{0}^{1} \vert {x}_{t} ) ) ) + {D}_{cosine} ( D I N O ( S A M ( {X}_{0} ) ) , D I N O ( S A M ( {\hat{x}}_{0}^{2} \vert {x}_{t}^{2} ) ) ) ) ,$$

where DINO(SAM(X₀)) may represent features of the content for the content image 734 as determined by the pretrained encoder 726, where

$$D I N O ( S A M ( {\hat{x}}_{0}^{1} \vert {x}_{t} ) )$$

may represent features of the content for the estimated generated image 708 at a first time step using a first noise sample. In some cases,

$$D I N O ( S A M ( {\hat{x}}_{0}^{2} \vert {x}_{t}^{2} ) )$$

may represent features of the content for the estimated generated image 708 at a second time step using a second noise sample. In some cases, the operations of the portion of the content loss 716 that is based on Lang-SAM may be similar to the operations of the contrastive loss described above, but focused on the specific content and excluding the background. Thus, the cosine similarity may be determined on just the features of the content and without considering the background. By focusing on just the relevant content (e.g., content identified based on the prompt) without irrelevant content, irrelevant content (e.g., background) leakage may be reduced. In some cases, the Lang-SAM may be applied in addition to, or instead of, the portion of the content loss 716 that may enforce preserving the content from the content image 734.

As indicated above, the text embedding, style embedding, and content embedding may be combined (e.g., by combiner 744) for integration into the pretrained generative ML model 702. In some cases, adaptive instance normalization (AdaIN) or the like may be used to combine the embeddings. For example, the text encoder 740 of the text adapter 738 may receive a text prompt and perform cross-attention (CA) (e.g., via cross-attention layers 742) on the text such that:

$$C {A}_{text} = softmax ( \frac{Q {K}_{text}^{T}}{\sqrt{d}} ) * {V}_{text} .$$

The query Q, key

$${K}_{text}^{T} ,$$

and values Vₜₑₓₜ, may be output by one or more cross-attention layers 742 for performing CA. In some cases, a CA operation combining text and content may combine cross-attention layers 742 and cross-attention layers 732. A CA operation combining text and style may combine cross-attention layers 742 and cross-attention layers 724. A CA operation combining text, style, and images may combine cross-attention layers 742, cross-attention layers 732, and cross-attention layers 724. In some cases, similar cross-attentions may be determined for the content features and style features. For example, CA may be performed on the style features such that

$$C {A}_{style} = softmax ( \frac{Q {K}_{style}^{T}}{\sqrt{d}} ) * {V}_{style} ,$$

and CA may e performed on the content features such that

$$C {A}_{content} = softmax ( \frac{Q {K}_{content}^{T}}{\sqrt{d}} ) * {V}_{content} .$$

AdaIN may be expressed such that

$$Ada I N ( x , y ) = σ ( y ) \cdot ( \frac{x - μ ( x )}{σ ( x )} ) + μ ( y ) ,$$

and combining the encodings may be expressed as Z_{composition}=CAₜₑₓₜ+α·AdaIN(CA_{style}, CAₜₑₓₜ)+β·AdaIN(CA_{content}, CAₜₑₓₜ). In some cases, AdaIN(CA_{style}, CAₜₑₓₜ) may project the style CA into a standard deviation and mean of the text CA (which the pretrained generative ML model 702 expects). Similarly, AdaIN(CA_{content}, CAₜₑₓₜ) may project the content CA into a standard deviation and mean of the text CA.

In some cases, the embeddings may be combined (e.g., by combiner 744) as a weighted summation. The weighted summation may weight and sum the style CA and content CA with the text CA of the pretrained generative ML model 702, such that

$${z}_{composition} = C {A}_{text} + {α}_{1} \cdot C {A}_{style} + {α}_{2} \cdot C {A}_{content} , where C {A}_{text} = softmax ( \frac{Q {K}_{t e x t}^{T}}{\sqrt{d}} ) * {V}_{text} , C {A}_{style} = softmax ( \frac{Q {K}_{style}^{T}}{\sqrt{d}} ) * {V}_{style} , and C {A}_{content} = softmax ( \frac{Q {K}_{content}^{T}}{\sqrt{d}} ) * {V}_{content} .$$

In some cases, the embeddings may be combined (e.g., by combiner 744) using attention feature aggregation. In attention feature aggregation, the text CA, style CA, and content CA may be defined, as above as, such that

$$C {A}_{text} = softmax ( \frac{Q {K}_{text}^{T}}{\sqrt{d}} ) * {V}_{text} , C {A}_{style} = softmax ( \frac{Q {K}_{style}^{T}}{\sqrt{d}} ) * {V}_{style} , and C {A}_{content} = softmax ( \frac{Q {K}_{content}^{T}}{\sqrt{d}} ) * {V}_{content} .$$

A CA of the content and style may be determined such that

$$C {A}_{content\_style} = softmax ( \frac{Q [ {K}_{content}^{T} ; {K}_{style}^{T} ]}{\sqrt{d}} ) * [ {V}_{content} ; {V}_{style} ] .$$

The combined embedding may then be described as Z_{composition}=Average(CAₜₑₓₜ, CA_{style}, CA_{content}, CA_{content_style}).

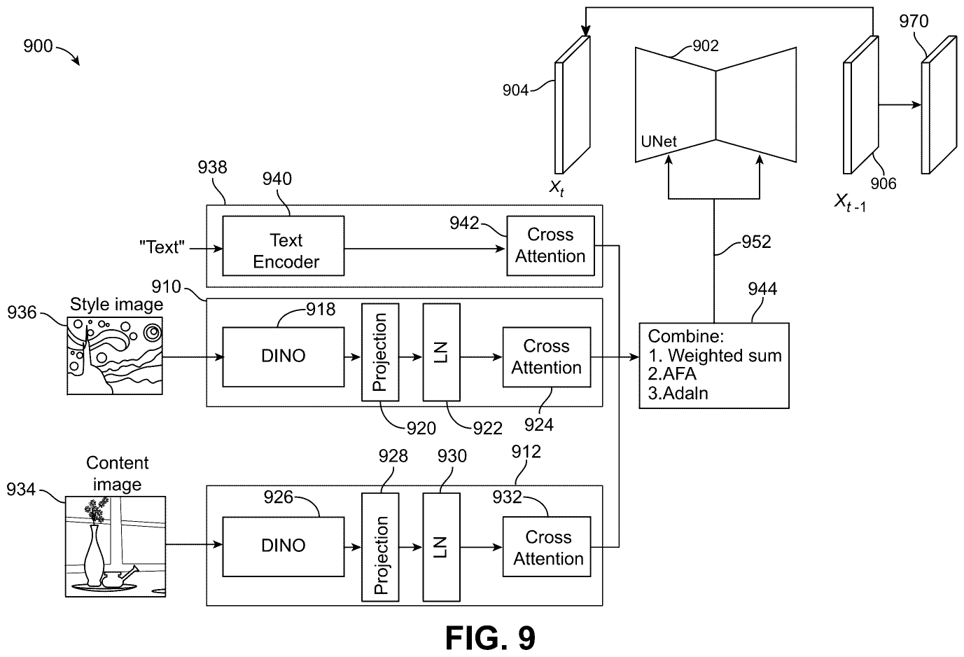

FIG. 9 illustrates an architecture for a ML model for generalized zero-shot content-style composition 900 for generating images, in accordance with aspects of the present disclosure. FIG. 9 may be similar to FIG. 7, and like components may be similarly numbered. During inference (e.g., after training) a style image 936 and a content image 934 may be input to a style adapter 910 and a content adapter 912, respectively. A text prompt may also be input to a text encoder 940 and processed by cross-attention layers 942 of a text adapter 938. A noise image 904 may also be input as a seed for a pretrained generative ML model 902.

The style adapter 910 may include a pretrained encoder 918, such as an object detector ML model, along with one or more trained (e.g., as described with respect to FIG. 7) projection layers 920, linear layers 922, and/or cross-attention layers 924. The style adapter 910 may generate features describing style information from the style image 936 in a manner substantially similar to that described above with respect to FIG. 7.

Similarly, the content adapter 912 may include a pretrained encoder 926, such as an object detector ML model, along with one or more trained (e.g., as described with respect to FIG. 7) projection layers 928, linear layers 930, and/or cross-attention layers 932. The content adapter may generate features describing content information from the content image 934 in a manner substantially similar to that described above with respect to FIG. 7.

The content information, style information, and text information may be combined by combiner 944 into combined embeddings 752 in a manner substantially similar to that described above with respect to combiner 744 of FIG. 7. The combined embeddings 952 (e.g., the combined embedding 752 of FIG. 7) may be input (e.g., injected) into the pretrained generative ML model 902. In some cases, the pretrained generative ML model 902 may be a diffusion model that can process a noise image 904 and generate a new image 906 based at least in part on the noise image 904 and the combined embeddings 952 from the content adapter 912 and style adapter 910. In some cases, the new image 906 may be used as the noise image 904 in a next iteration of the pretrained generative ML model 902, where the noise image 904 can be input to the pretrained generative ML model 902 to generate another new image 906 based the combined embedding at the next iteration. The loop may be repeated a number of times until an output image 970 is generated. The output image 970 may include content from the content image 934 and may be in the style of the style image 936.

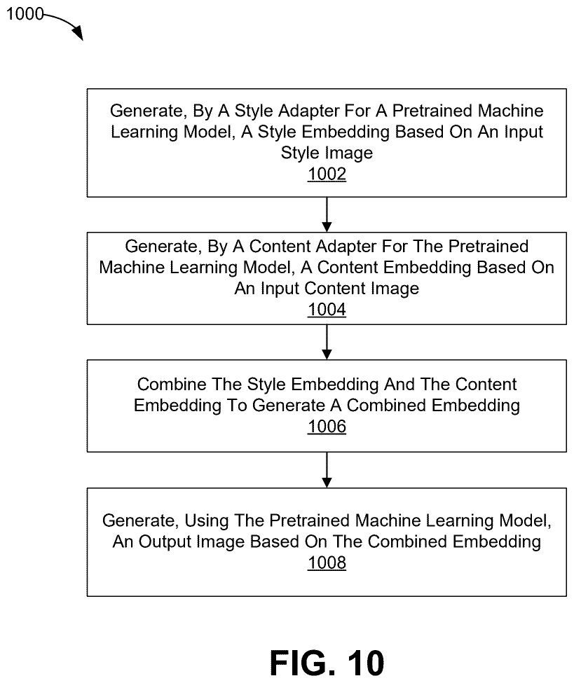

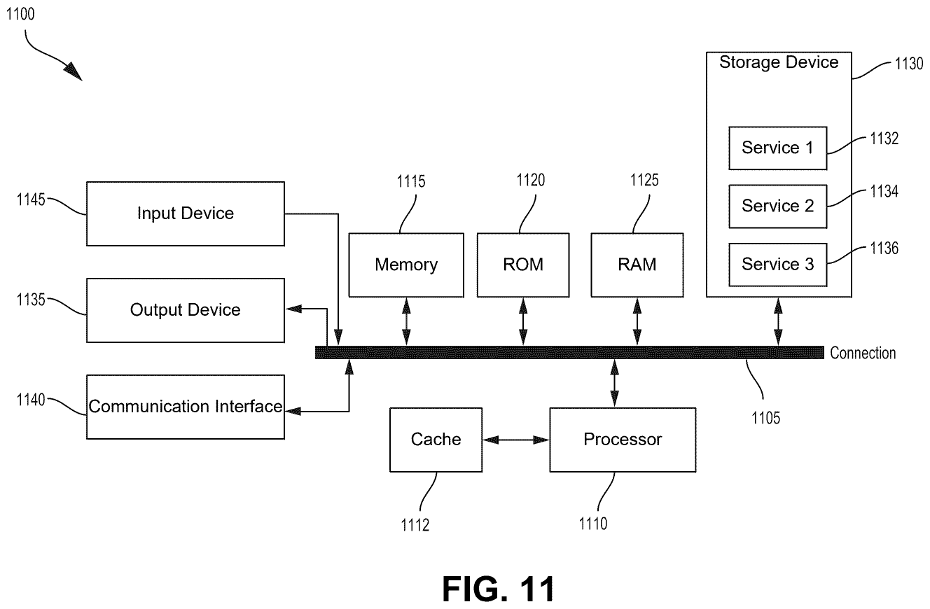

FIG. 10 is a flow diagram illustrating a process 1000 for generating an image, in accordance with aspects of the present disclosure. The process 1000 may be performed by a computing device (or apparatus) (e.g., SOC 100 of FIG. 1, computing device architecture 1100 of FIG. 11) or a component (e.g., a chipset, codec, CPU 102, GPU 104, DSP 106, NPU 108 of FIG. 1, processor 1110 of FIG. 11, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors.

At block 1002, the computing device (or component thereof) may generate, using a style adapter (e.g., style adapter 710 of FIG. 7, style adapter 910 of FIG. 9) for a pretrained machine learning model (e.g., pretrained generative ML model 702 of FIG. 7, pretrained generative ML model 902 of FIG. 9), a style embedding based on an input style image (e.g., style image 736 of FIG. 7, style image 936 of FIG. 9). In some cases, the style adapter includes one of a style recognition model (e.g., style recognition ML model, such as contrastive style descriptor (CSD)) model or an object detector model (e.g., object detector ML model, such as DINO, DINOv2, etc.) for encoding a style of the input style image. In some examples, the pretrained machine learning model comprises a diffusion model. In some cases, the output image is generated based on a noise image (e.g., noise image 704 of FIG. 7, noise image 904 of FIG. 9). In some examples, the style adapter includes one or more projection layers, linear layers, and/or cross-attention layers.

At block 1004, the computing device (or component thereof) may generate, using a content adapter (e.g., content adapter 712 of FIG. 7, content adapter 912 of FIG. 9) for the pretrained machine learning model, a content embedding based on an input content image (e.g., content image 734 of FIG. 7, content image 934 of FIG. 9). In some cases, the content adapter includes an object detector model for encoding content of the input content image. In some cases, the content adapter includes one or more projection layers, linear layers, and/or cross-attention layers.

At block 1006, the computing device (or component thereof) may combine (e.g., by combiner 744 of FIG. 7, combiner 944 of FIG. 9) the style embedding and the content embedding to generate a combined embedding (e.g., combined embedding 752 of FIG. 7, combined embedding 952 of FIG. 9). In some cases, the computing device (or component thereof) may combine the style embedding and content embedding by performing at least one of a weighted summation, attention feature aggregation, or an adaptive instance normalization to combine the style embedding and content embedding.

At block 1008, the computing device (or component thereof) may generate, using the pretrained machine learning model, an output image (e.g., output image 970 of FIG. 9) based on the combined embedding (and in some cases based on a noise image, such as noise image 704 of FIG. 7, noise image 904 of FIG. 9). In some examples, the computing device (or component thereof) may predict an estimated generated image (e.g., estimated generated image 708 of FIG. 7) based on a first intermediate image (e.g., new image 706 of FIG. 7) that was generated from a noise image (e.g., noise image 704 of FIG. 7, noise image 904 of FIG. 9) based on the combined embedding. In some cases, the computing device (or component thereof) may generate, using a style recognition model (e.g., CSD 746 of FIG. 7), first style information for the input style image; generate, using the style recognition model, second style information for the estimated generated image; determine a style loss (e.g., style loss 714 of FIG. 7) based on the first style information and the second style information; and update weights of the style adapter based on the style loss. In some examples, the style loss is determined based on a cosine similarity between the first style information and the second style information. In some cases, the computing device (or component thereof) may generate, using an object detector model (e.g., DINO 750 of FIG. 7), first content information for the input content image, generate, using the object detector model, second content information for the estimated generated image, determine a content loss (e.g., content loss 716 of FIG. 7) based on the first content information and the second content information, and update weights of the content adapter based on the content loss. In some examples, the computing device (or component thereof) may determine the content loss by performing a cosine similarity operation between the first intermediate image and a second intermediate image to preserve content from the input content image, wherein the second intermediate image is generated for a different time step as compared to the first intermediate image. In some cases, the computing device (or component thereof) may determine the content loss by identifying content in the input content image based on a language segment anything model (e.g., Lang-Sam 804 of FIG. 8), and identifying content in the first intermediate image based on the language segment anything model. In some examples, the content loss is based on a similarity between the identified content in the input content image and the identified content in the first intermediate image. In some cases, the computing device (or component thereof) may determine the content loss by identifying content in a second intermediate image based on the language segment anything model. In some examples, the second intermediate image is generated for a different time step compared to the first intermediate image. In some cases, the content loss is based on a similarity between the identified content in the input content image and the identified content in the second intermediate image.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1000 and/or other processes described herein may include a processor, microprocessor, micro-computer, or other component of a device that is configured to carry out the steps of the process 1000 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1000 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1000 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 illustrates an example computing device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1100 are shown in electrical communication with each other using connection 1105, such as a bus. The example computing device architecture 1100 includes a processing unit (CPU or processor) 1110 and computing device connection 1105 that couples various computing device components including computing device memory 1115, such as read only memory (ROM) 1120 and random access memory (RAM) 1125, to processor 1110.

Computing device architecture 1100 can include a cache of high-speed memory connected directly with, in close proximity to, or integrated as part of processor 1110. Computing device architecture 1100 can copy data from memory 1115 and/or the storage device 1130 to cache 1112 for quick access by processor 1110. In this way, the cache can provide a performance boost that avoids processor 1110 delays while waiting for data. These and other modules can control or be configured to control processor 1110 to perform various actions. Other computing device memory 1115 may be available for use as well. Memory 1115 can include multiple different types of memory with different performance characteristics. Processor 1110 can include any general purpose processor and a hardware or software service, such as service 1 1132, service 2 1134, and service 3 1136 stored in storage device 1130, configured to control processor 1110 as well as a special-purpose processor where software instructions are incorporated into the processor design. Processor 1110 may be a self-contained system, containing multiple cores or processors, a bus, memory controller, cache, etc. A multi-core processor may be symmetric or asymmetric.

To enable user interaction with the computing device architecture 1100, input device 1145 can represent any number of input mechanisms, such as a microphone for speech, a touch-sensitive screen for gesture or graphical input, keyboard, mouse, motion input, speech and so forth. Output device 1135 can also be one or more of a number of output mechanisms known to those of skill in the art, such as a display, projector, television, speaker device, etc. In some instances, multimodal computing devices can enable a user to provide multiple types of input to communicate with computing device architecture 1100. Communication interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. Storage device 1130 can include services 1132, 1134, 1136 for controlling processor 1110. Other hardware or software modules are contemplated. Storage device 1130 can be connected to the computing device connection 1105. In one aspect, a hardware module that performs a particular function can include the software component stored in a computer-readable medium in connection with the necessary hardware components, such as processor 1110, connection 1105, output device 1135, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating an image, comprising: at least one memory; and at least one processor coupled to the at least one memory and configured to: generate, using a style adapter for a pretrained machine learning model, a style embedding based on an input style image; generate, using a content adapter for the pretrained machine learning model, a content embedding based on an input content image; combine the style embedding and the content embedding to generate a combined embedding; and generate, using the pretrained machine learning model, an output image based on the combined embedding.
Aspect 2. The apparatus of Aspect 1, wherein the style adapter includes one of a pretrained style recognition model or a pretrained object detector model for encoding a style of the input style image.
Aspect 3. The apparatus of any of Aspects 1-2, wherein the content adapter includes a pretrained object detector model for encoding content of the input content image.
Aspect 4. The apparatus of any of Aspects 1-3, wherein, to combine the style embedding and content embedding, the at least one processor is configured to perform at least one of a weighted summation, attention feature aggregation, or an adaptive instance normalization to combine the style embedding and content embedding.
Aspect 5. The apparatus of any of Aspects 1-4, wherein the pretrained machine learning model comprises a diffusion model, and wherein the output image is generated based on a noise image.
Aspect 6. The apparatus of any of Aspects 1-5, wherein the at least one processor is configured to predict an estimated generated image based on a first intermediate image that was generated from a noise image based on the combined embedding.
Aspect 7. The apparatus of Aspect 6, wherein the at least one processor is configured to: generate, using a style recognition model, first style information for the input style image; generate, using the style recognition model, second style information for the estimated generated image; determine a style loss based on the first style information and the second style information; and update weights of the style adapter based on the style loss.
Aspect 8. The apparatus of Aspect 7, wherein the style loss is determined based on a cosine similarity between the first style information and the second style information.
Aspect 9: The apparatus of any of Aspects 7-8, wherein, to update weights of the style adapter based on the style loss, the at least one processor is configured to update weights of one or more projection layers, linear layers, or cross-attention layers of the style adapter based on the style loss.
Aspect 10. The apparatus of any of Aspects 6-9, wherein the at least one processor is configured to: generate, using an object detector model, first content information for the input content image; generate, using the object detector model, second content information for the estimated generated image; determine a content loss based on the first content information and the second content information; and update weights of the content adapter based on the content loss.
Aspect 11: The apparatus of Aspect 10, wherein, to update weights of the content adapter based on the content loss, the at least one processor is configured to update weights of one or more projection layers, linear layers, or cross-attention layers of the content adapter based on the content loss.
Aspect 12. The apparatus of any of Aspects 10-11, wherein, to determine the content loss, the at least one processor is configured to perform a cosine similarity operation between the first intermediate image and a second intermediate image to preserve content from the input content image, wherein the second intermediate image is generated for a different time step as compared to the first intermediate image.
Aspect 13. The apparatus of any of Aspects 10-12, wherein, to determine the content loss, the at least one processor is configured to: identify content in the input content image based on a language segment anything model; and identify content in the first intermediate image based on the language segment anything model, and wherein the content loss is based on a similarity between the identified content in the input content image and the identified content in the first intermediate image.
Aspect 14. The apparatus of Aspect 13, wherein, to determine the content loss, the at least one processor is configured to identify content in a second intermediate image based on the language segment anything model, wherein the second intermediate image is generated for a different time step compared to the first intermediate image, and wherein the content loss is based on a similarity between the identified content in the input content image and the identified content in the second intermediate image.
Aspect 15. The apparatus of any of Aspects 1-14, wherein the style adapter includes one or more projection layers, linear layers, or cross-attention layers, and wherein the content adapter includes one or more projection layers, linear layers, or cross-attention layers.
Aspect 16: The apparatus of any of Aspects 1-15, wherein the style adapter and the content adapter are trained separately based on separate training datasets.
Aspect 17. A method for generating an image, comprising: generating, by a style adapter for a pretrained machine learning model, a style embedding based on an input style image; generating, by a content adapter for the pretrained machine learning model, a content embedding based on an input content image; combining the style embedding and the content embedding to generate a combined embedding; and generating, using the pretrained machine learning model, an output image based on the combined embedding.
Aspect 18. The method of Aspect 17, wherein the style adapter includes one of a pretrained style recognition model or a pretrained object detector model for encoding a style of the input style image.
Aspect 19. The method of any of Aspects 17-18, wherein the content adapter includes a pretrained object detector model for encoding content of the input content image.
Aspect 20. The method of any of Aspects 17-19, wherein combining the style embedding and content embedding comprises performing at least one of a weighted summation, attention feature aggregation, or an adaptive instance normalization to combine the style embedding and content embedding.
Aspect 21. The method of any of Aspects 17-20, wherein the pretrained machine learning model comprises a diffusion model, and wherein the output image is generated based on a noise image.
Aspect 22. The method of any of Aspects 17-21, further comprising predicting an estimated generated image based on a first intermediate image that was generated from a noise image based on the combined embedding.
Aspect 23. The method of Aspect 22, further comprising: generating, by a style recognition model, first style information for the input style image; generating, by the style recognition model, second style information for the estimated generated image; determining a style loss based on the first style information and the second style information; and updating weights of the style adapter based on the style loss.
Aspect 24: The method of Aspect 23, wherein updating weights of the style adapter based on the style loss comprises updating weights of one or more projection layers, linear layers, or cross-attention layers of the style adapter based on the style loss.
Aspect 25. The method of any of Aspects 23-24, wherein the style loss is determined based on a cosine similarity between the first style information and the second style information.
Aspect 26. The method of any of Aspects 22-25, further comprising: generating by an object detector model, first content information for the input content image; generating, by the object detector model, second content information for the estimated generated image; determining a content loss based on the first content information and the second content information; and updating weights of the content adapter based on the content loss.
Aspect 27: The method of Aspect 26, wherein updating weights of the content adapter based on the content loss comprises updating weights of one or more projection layers, linear layers, or cross-attention layers of the content adapter based on the content loss.
Aspect 28. The method of any of Aspects 26-27, wherein determining the content loss comprises performing a cosine similarity operation between the first intermediate image and a second intermediate image to preserve content from the input content image, wherein the second intermediate image is generated for a different time step as compared to the first intermediate image.
Aspect 29. The method of any of Aspects 26-28, wherein determining the content loss comprises: identifying content in the input content image based on a language segment anything model; and identifying content in the first intermediate image based on the language segment anything model, and wherein the content loss is based on a similarity between the identified content in the input content image and the identified content in the first intermediate image.
Aspect 30. The method of Aspect 29, wherein determining the content loss comprises identifying content in a second intermediate image based on the language segment anything model, wherein the second intermediate image is generated for a different time step compared to the first intermediate image, and wherein the content loss is based on a similarity between the identified content in the input content image and the identified content in the second intermediate image.
Aspect 31. The method of any of Aspects 22-30, wherein the style adapter includes one or more projection layers, linear layers, or cross-attention layers, and wherein the content adapter includes one or more projection layers, linear layers, or cross-attention layers.
Aspect 32. The method of Aspect 22-31, wherein the style adapter and the content adapter are trained separately based on separate training datasets.
Aspect 33: A non-transitory computer-readable medium having stored thereon instructions that, when executed by at least one processor, cause the at least one processor to perform operations according to any Aspects 17-32.
Aspect 34: An apparatus comprising one or more means for performing operations according to any one or more of Aspects 17-32.
Aspect 35: An apparatus for generating an image, comprising means for generating, by a style adapter for a pretrained machine learning model, a style embedding based on an input style image; means for generating, by a content adapter for the pretrained machine learning model, a content embedding based on an input content image; means for combining the style embedding and the content embedding to generate a combined embedding; and means for generating, using the pretrained machine learning model, an output image based on the combined embedding.

What is claimed is:

1. An apparatus for generating an image, comprising:
at least one memory; and
at least one processor coupled to the at least one memory and configured to:
generate, using a style adapter for a pretrained machine learning model, a style embedding based on an input style image;
generate, using a content adapter for the pretrained machine learning model, a content embedding based on an input content image;
combine the style embedding and the content embedding to generate a combined embedding; and
generate, using the pretrained machine learning model, an output image based on the combined embedding.

2. The apparatus of claim 1, wherein the style adapter includes one of a pretrained style recognition model or a pretrained object detector model for encoding a style of the input style image.

3. The apparatus of claim 1, wherein the content adapter includes a pretrained object detector model for encoding content of the input content image.

4. The apparatus of claim 1, wherein, to combine the style embedding and content embedding, the at least one processor is configured to perform at least one of a weighted summation, attention feature aggregation, or an adaptive instance normalization to combine the style embedding and content embedding.

5. The apparatus of claim 1,
wherein the pretrained machine learning model comprises a diffusion model, and
wherein the output image is generated based on a noise image.

6. The apparatus of claim 1, wherein the at least one processor is configured to predict an estimated generated image based on a first intermediate image that was generated from a noise image based on the combined embedding.

7. The apparatus of claim 6, wherein the at least one processor is configured to:
generate, using a style recognition model, first style information for the input style image;
generate, using the style recognition model, second style information for the estimated generated image;
determine a style loss based on the first style information and the second style information; and
update weights of the style adapter based on the style loss.

8. The apparatus of claim 7, wherein the style loss is determined based on a cosine similarity between the first style information and the second style information.

9. The apparatus of claim 6, wherein the at least one processor is configured to:
generate by an object detector model, first content information for the input content image;
generate, using the object detector model, second content information for the estimated generated image;
determine a content loss based on the first content information and the second content information; and
update weights of the content adapter based on the content loss.

10. The apparatus of claim 9,
wherein, to determine the content loss, the at least one processor is configured to perform a cosine similarity operation between the first intermediate image and a second intermediate image to preserve content from the input content image,
wherein the second intermediate image is generated for a different time step as compared to the first intermediate image.

11. The apparatus of claim 9, wherein, to determine the content loss, the at least one processor is configured to:
identify content in the input content image based on a language segment anything model; and
identify content in the first intermediate image based on the language segment anything model, and wherein the content loss is based on a similarity between the identified content in the input content image and the identified content in the first intermediate image.

12. The apparatus of claim 11,
wherein, to determine the content loss, the at least one processor is configured to identify content in a second intermediate image based on the language segment anything model,
wherein the second intermediate image is generated for a different time step compared to the first intermediate image, and
wherein the content loss is based on a similarity between the identified content in the input content image and the identified content in the second intermediate image.

13. The apparatus of claim 1,
wherein the style adapter includes one or more projection layers, linear layers, or cross-attention layers, and
wherein the content adapter includes one or more projection layers, linear layers, or cross-attention layers.

14. A method for generating an image, comprising:
generating, by a style adapter for a pretrained machine learning model, a style embedding based on an input style image;
generating, by a content adapter for the pretrained machine learning model, a content embedding based on an input content image;
combining the style embedding and the content embedding to generate a combined embedding; and
generating, using the pretrained machine learning model, an output image based on the combined embedding.

15. The method of claim 14, wherein the style adapter includes one of a pretrained style recognition model or a pretrained object detector model for encoding a style of the input style image.

16. The method of claim 14, wherein the content adapter includes a pretrained object detector model for encoding content of the input content image.

17. The method of claim 14, wherein combining the style embedding and content embedding comprises performing at least one of a weighted summation, attention feature aggregation, or an adaptive instance normalization to combine the style embedding and content embedding.

18. The method of claim 14, wherein the pretrained machine learning model comprises a diffusion model, and wherein the output image is generated based on a noise image.

19. The method of claim 14, further comprising predicting an estimated generated image based on a first intermediate image that was generated from a noise image based on the combined embedding.

20. The method of claim 19, further comprising:
generating, by a style recognition model, first style information for the input style image;
generating, by the style recognition model, second style information for the estimated generated image;
determining a style loss based on the first style information and the second style information; and
updating weights of the style adapter based on the style loss.

21. The method of claim 20, wherein the style loss is determined based on a cosine similarity between the first style information and the second style information.

22. The method of claim 19, further comprising:
generating by an object detector model, first content information for the input content image;
generating, by the object detector model, second content information for the estimated generated image;
determining a content loss based on the first content information and the second content information; and
updating weights of the content adapter based on the content loss.

23. The method of claim 22, wherein determining the content loss comprises performing a cosine similarity operation between the first intermediate image and a second intermediate image to preserve content from the input content image, wherein the second intermediate image is generated for a different time step as compared to the first intermediate image.

24. The method of claim 22, wherein determining the content loss comprises:
identifying content in the input content image based on a language segment anything model; and
identifying content in the first intermediate image based on the language segment anything model, and wherein the content loss is based on a similarity between the identified content in the input content image and the identified content in the first intermediate image.

25. The method of claim 24, wherein determining the content loss comprises identifying content in a second intermediate image based on the language segment anything model, wherein the second intermediate image is generated for a different time step compared to the first intermediate image, and wherein the content loss is based on a similarity between the identified content in the input content image and the identified content in the second intermediate image.

26. The method of claim 14, wherein the style adapter includes one or more projection layers, linear layers, or cross-attention layers, and wherein the content adapter includes one or more projection layers, linear layers, or cross-attention layers.

27. An apparatus for generating an image, comprising:
means for generating, by a style adapter for a pretrained machine learning model, a style embedding based on an input style image;
means for generating, by a content adapter for the pretrained machine learning model, a content embedding based on an input content image;
means for combining the style embedding and the content embedding to generate a combined embedding; and
means for generating, using the pretrained machine learning model, an output image based on the combined embedding.
